(19) United States
(12) Patent Application Publication
(10) Pub. No.: US 2019/0010851 A1
(43) Pub. Date: Jan. 10, 2019

(54) SELECTIVE CATALYTIC REDUCTION STEADY STATE AMMONIA SLIP AND REDUCTANT BREAKTHROUGH DETECTION

(71) Applicant: GM Global Technology Operations LLC, Detroit, MI (US)

(72) Inventors: Sarah Funk, Canton, MI (US); Charles E. Dean, Clarkston, MI (US); Po-I Lee, Rochester Hills, MI (US); David P. Quigley, Brighton, MI (US)

(21) Appl. No.: 15/643,987

(22) Filed: Jul. 7, 2017

(51) Int. Cl. F01N 11/00; F01N 3/20; F02D 41/00; B01D 53/94

(52) U.S. Cl. CPC F01N 11/00; F01N 3/208; F02D 41/0055; F01N 2610/02; B01D 53/9495; F01N 2550/05; F01N 2550/02; B01D 53/9418

(57) ABSTRACT

Technical solutions are described for an emissions control system for a motor vehicle including an internal combustion engine. An example emissions control system for treating exhaust gas in a motor vehicle including an internal combustion engine. For example, the emissions control system includes a selective catalytic reduction (SCR) device, an NOx sensor, and a controller that is configured to detect a NH3 slip of the SCR device. The controller detects the NH3 slip by modulating an engine out NOx from an engine, demodulating the engine out NOx from the engine to original state, and measuring NOx upstream and downstream from the SCR device after the modulation. Further, the controller determines the NH3 slip by comparing gradients in the NOx measurement with one or more predetermined thresholds.

### INTRODUCTION

The present disclosure relates to exhaust systems for internal combustion engines, and more particularly to exhaust systems using selective catalytic reduction (SCR) units for emission control.

Exhaust gas emitted from an internal combustion engine, particularly a diesel engine, is a heterogeneous mixture that contains gaseous emissions such as carbon monoxide (“CO”), unburned hydrocarbons (“HC”) and oxides of nitrogen (“NOₓ”) as well as condensed phase materials (liquids and solids) that constitute particulate matter (“PM”). Catalyst compositions, typically disposed on catalyst supports or substrates, are provided in an engine exhaust system as part of an aftertreatment system to convert certain, or all of these exhaust constituents into non-regulated exhaust gas components.

Exhaust gas treatment systems typically include selective catalytic reduction (SCR) devices. An SCR device includes a substrate having an SCR catalyst disposed thereon to reduce the amount of NOx in the exhaust gas. The typical exhaust treatment system also includes a reductant delivery system that injects a reductant such as, for example, ammonia (NH3), urea (CO(NH2)2, etc.). The SCR device makes use of NH3 to reduce the NOx. For example, when the proper amount of NH3 is supplied to the SCR device under the proper conditions, the NH3 reacts with the NOx in the presence of the SCR catalyst to reduce the NOx emissions. However, if the reduction reaction rate is too slow, or if there is excess ammonia in the exhaust, ammonia can slip from the SCR. On the other hand, if there is too little ammonia in the exhaust, SCR NOx conversion efficiency will be decreased.

### SUMMARY

One or more embodiments are described of an emissions control system for treating exhaust gas in a motor vehicle including an internal combustion engine. For example, the emissions control system includes a selective catalytic reduction (SCR) device, an NOx sensor, and a controller that is configured to detect a NH3 slip of the SCR device. The controller detects the NH3 slip by modulating an engine out NOx from an engine, demodulating the engine out NOx from the engine to original state, and measuring NOx upstream and downstream from the SCR device after the modulation. Further, the controller determines the NH3 slip by comparing gradients in the NOx measurement with one or more predetermined thresholds.

In one or more examples, the SCR device is determined to be overdosed in response to a gradient of the NOx measurement corresponding to a rise in SCR out NOx, which is measured downstream from the SCR device, not meeting a predetermined threshold. In one or more examples, the SCR device is determined to be underdosed in response to a gradient of the NOx measurement corresponding to a reduction in the SCR out NOx, which is measured downstream from the SCR device, exceeding a predetermined threshold.

Further the controller adapts the SCR device in response to the NH3 slip being detected.

Further, the controller determines an operating state of the engine, and initializes the detection of the NH3 slip of the SCR device in response to the engine operating in a steady state.

In one or more examples, the controller detects the NH3 slip in the steady state at a predetermined frequency.

In one or more examples, the controller modulates the engine out NOx of the engine by cycling an exhaust gas recirculation of the engine. The modulation of the engine out NOx of the engine includes multiple modulations, the NOx measurement includes corresponding multiple NOx measurements, and the comparison includes determining a correlation between the NOx measurements and a predetermined set of predicted NOx measurements and frequency detection of the NOx measurements.

Further, the controller detects the NH3 slip by demodulating the engine out NOx from the engine to original state.

One or more embodiments are described of an exhaust system for treating exhaust gas emitted by an internal combustion engine, that performs a selective catalytic reduction (SCR) of exhaust gas. In one or more examples, the exhaust system includes a controller to detect a NH3 slip of an SCR device by: modulating an engine out NOx from an engine; measuring NOx downstream from the SCR device after the modulation; and determining the NH3 slip by comparing gradients in the NOx measurement with one or more predetermined thresholds.

In one or more examples, the SCR device is determined to be overdosed in response to a gradient of the NOx measurement corresponding to a rise in NOx measurement downstream from the SCR device not meeting a predetermined threshold. Further, in one or more examples, the SCR device is determined to be underdosed in response to a gradient of the NOx measurement corresponding to a reduction in NOx measurement downstream from the SCR device exceeding a predetermined threshold.

In one or more examples, the controller further determines an operating state of the engine, and initializes the detection of the NH3 slip of the SCR device in response to the engine operating in a steady state. In one or more examples, the controller detects the NH3 slip in the steady state at a predetermined frequency. In one or more examples, the controller modulates the engine out NOx of the engine by cycling an exhaust gas recirculation of the engine. In one or more examples, the detection of the NH3 slip further includes demodulating the engine out NOx from the engine.

One or more embodiments are described of a computer-implemented method for controlling a selective catalytic reduction (SCR) device of an exhaust system of an internal combustion engine. For example, the method includes modulating an engine out NOx from the internal combustion engine; measuring NOx downstream from the SCR device after the modulation; and determining a dosing status of the SCR device by comparing gradients in the NOx measurement with one or more predetermined thresholds, the dosing status indicative of the SCR device being underdosed or overdosed.

In one or more examples, the dosing status of the SCR device is determined to be overdosed in response to a gradient of the NOx measurement corresponding to a rise in the NOx measurement downstream from the SCR device not meeting a predetermined threshold. Further, in one or more examples, the dosing status of the SCR device is determined to be underdosed in response to a gradient of the NOx measurement corresponding to a reduction in the NOx measurement downstream from the SCR device exceeding a predetermined threshold.

Further, the method includes determining an operating state of the engine, and initializes the detection of the NH3 slip of the SCR device in response to the engine operating in a steady state. In one or more examples, the NH3 slip is detected in the steady state at a predetermined frequency. In one or more examples, modulating the engine out NOx of the engine includes cycling an exhaust gas recirculation of the engine. In one or more examples, the detection of the NH3 slip further includes demodulating the engine out NOx from the engine.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a motor vehicle including an internal combustion engine and an emission control system according to one or more embodiments;

FIG. 2 illustrates example components of an emissions control system according to one or more embodiments;

FIG. 3 illustrates an example flow of the gases through an SCR device, according to one or more embodiments;

FIG. 4 illustrates an example scenario where an SCR device is underdosed;

FIG. 5 illustrates a flowchart of an exemplary method for detecting ammonia slip in an SCR device according to one or more embodiments;

FIG. 6 illustrates a flowchart of an exemplary method for detecting ammonia slip in an SCR device according to one or more embodiments;

FIG. 7 illustrates a flowchart of an exemplary method for detecting ammonia slip in an SCR device according to one or more embodiments; and

FIG. 8 illustrates example sequences of NOx measurements and engine out NOx modulations according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

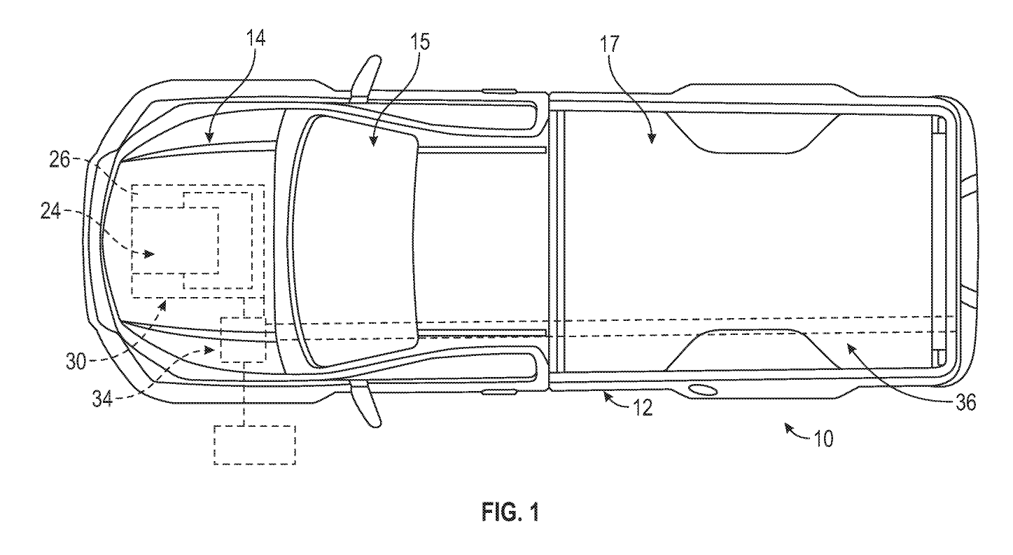

A motor vehicle, in accordance with an aspect of an exemplary embodiment, is indicated generally at 10 in FIG. 1. Motor vehicle 10 is shown in the form of a pickup truck. It is to be understood that motor vehicle 10 may take on various forms including automobiles, commercial transports, marine vehicles, and the like. Motor vehicle 10 includes a body 12 having an engine compartment 14, a passenger compartment 15, and a cargo bed 17. Engine compartment 14 houses an internal combustion engine system 24, which, in the exemplary embodiment shown, may include a diesel engine 26. Internal combustion engine system 24 includes an exhaust system 30 that is fluidically connected to an aftertreatment or emissions control system 34. Exhaust produced by internal combustion engine (ICE) system 24 passes through emissions control system 34 to reduce emissions that may exit to ambient through an exhaust outlet pipe 36.

It should be noted that technical solutions described herein are germane to ICE systems that can include, but are not limited to, diesel engine systems and gasoline engine systems. The ICE system 24 can include a plurality of reciprocating pistons attached to a crankshaft, which may be operably attached to a driveline, such as a vehicle driveline, to power a vehicle (e.g., deliver tractive torque to the driveline). For example, the ICE system 24 can be any engine configuration or application, including various vehicular applications (e.g., automotive, marine and the like), as well as various non-vehicular applications (e.g., pumps, generators and the like). While the ICEs may be described in a vehicular context (e.g., generating torque), other non-vehicular applications are within the scope of this disclosure. Therefore, when reference is made to a vehicle, such disclosure should be interpreted as applicable to any application of an ICE system.

Moreover, an ICE can generally represent any device capable of generating an exhaust gas stream comprising gaseous (e.g., NOₓ, O₂), carbonaceous, and/or particulate matter species, and the disclosure herein should accordingly be interpreted as applicable to all such devices. As used herein, “exhaust gas” refers to any chemical species or mixture of chemical species which may require treatment, and includes gaseous, liquid, and solid species. For example, an exhaust gas stream may contain a mixture of one or more NOₓ species, one or more liquid hydrocarbon species, and one more solid particulate species (e.g., ash). It should be further understood that the embodiments disclosed herein may be applicable to treatment of effluent streams not comprising carbonaceous and/or particulate matter species, and, in such instances, ICE 26 can also generally represent any device capable of generating an effluent stream comprising such species. Exhaust gas particulate matter generally includes carbonaceous soot, and other solid and/or liquid carbon-containing species which are germane to ICE exhaust gas or form within an emissions control system 34.

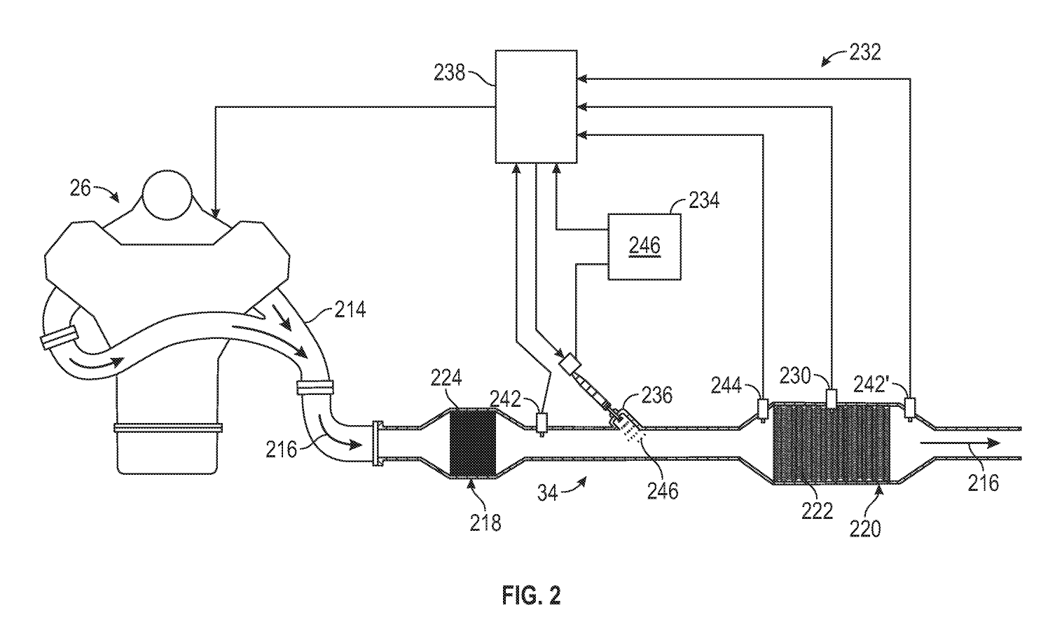

FIG. 2 illustrates example components of the emissions control system 34 according to one or more embodiments. It should be noted that while the internal combustions engine system 24 includes a diesel engine 26 in the above example, the emissions control system 34 described herein can be implemented in various engine systems. The emissions control system 34 facilitates the control and monitoring of NOₓ storage and/or treatment materials, to control exhaust produced by the internal combustion engine system 24. For example, the technical solutions herein provide methods for controlling selective catalytic reduction (SCR) devices, and appurtenant NOₓ sensors, wherein the SCR Devices are configured to receive exhaust gas streams from an exhaust gas source. As used herein, “NOₓ” refers to one or more nitrogen oxides. NOₓ species can include NA_{y}Oₓ species, wherein y>0 and x>0. Non-limiting examples of nitrogen oxides can include NO, NO₂, N₂O, N₂O₂, N₂O₃, N₂O₄, and N₂O₅. SCR Devices are configured to receive reductant, such as at variable dosing rates as will be described below.

The exhaust gas conduit 214, which may comprise several segments, transports exhaust gas 216 from the engine 26 to the various exhaust treatment devices of the emissions control system 34. For example, as illustrated, the emission control system 34 includes a SCR device 220. In one or more examples, the SCR device 220 can include a selective catalytic filter (SCRF) device, which provides the catalytic aspects of SCRs in addition to particulate filtering capabilities. Alternatively, or in addition, the SCR device 220 can also be coated on a flow-through substrate. As can be appreciated, system 34 can include various additional treatment devices, including an oxidation catalyst (OC) device 218, and particulate filter devices (not shown), among others.

As can be appreciated, the OC Device 218 can be of various flow-through, oxidation catalyst devices known in the art. In various embodiments the OC device 218 may include a flow-through metal or ceramic monolith substrate 224. The substrate 224 may be packaged in a stainless steel shell or canister having an inlet and an outlet in fluid communication with the exhaust gas conduit 214. The substrate 224 may include an oxidation catalyst compound disposed thereon. The oxidation catalyst compound may be applied as a washcoat and may contain platinum group metals such as platinum (Pt), palladium (Pd), rhodium (Rh) or other suitable oxidizing catalysts, or combination thereof. The OC Device 218 is useful in treating unburned gaseous and non-volatile HC and CO, which are oxidized to form carbon dioxide and water. A washcoat layer includes a compositionally distinct layer of material disposed on the surface of the monolithic substrate or an underlying washcoat layer. A catalyst can contain one or more washcoat layers, and each washcoat layer can have unique chemical catalytic functions. In the SCR device 220, the catalyst compositions for the SCR function and NH₃ oxidation function can reside in discrete washcoat layers on the substrate or, alternatively, the compositions for the SCR and NH₃ oxidation functions can reside in discrete longitudinal zones on the substrate.

The SCR device 220 may be disposed downstream from the OC device 218. In one or more examples, the SCR device 220 includes a filter portion 222 that can be a wall flow filter, which is configured to filter or trap carbon and other particulate matter from the exhaust gas 216. In at least one exemplary embodiment, the filter portion 222 is formed as a particulate filter (PF), such as a diesel particulate filter (DPF). The filter portion (i.e., the PF) may be constructed, for example, using a ceramic wall flow monolith exhaust gas filter substrate, which is packaged in a rigid, heat resistant shell or canister. The filter portion 222 has an inlet and an outlet in fluid communication with exhaust gas conduit 214 and may trap particulate matter as the exhaust gas 216 flows therethrough. It is appreciated that a ceramic wall flow monolith filter substrate is merely exemplary in nature and that the filter portion 222 may include other filter devices such as wound or packed fiber filters, open cell foams, sintered metal fibers, etc. The emissions control system 34 may also perform a regeneration process that regenerates the filter portion 222 by burning off the particulate matter trapped in the filter substrate, in one or more examples.

In one or more examples, the SCR device 220 receives reductant, such as at variable dosing rates. Reductant 246 can be supplied from a reductant supply source 246. In one or more examples, the reductant 246 is injected into the exhaust gas conduit 214 at a location upstream of the SCR device 220 using an injector 236, or other suitable method of delivery. The reductant 246 can be in the form of a gas, a liquid, or an aqueous solution, such as an aqueous urea solution. In one or more examples, the reductant 246 can be mixed with air in the injector 236 to aid in the dispersion of the injected spray. The catalyst containing washcoat disposed on the filter portion 222 or a flow through catalyst or a wall flow filter may reduce NOx constituents in the exhaust gas 216. The SCR device 220 utilizes the reductant 246, such as ammonia (NH₃), to reduce the NOx. The catalyst containing washcoat may contain a zeolite and one or more base metal components such as iron (Fe), cobalt (Co), copper (Cu), or vanadium (V), which can operate efficiently to convert NOx constituents of the exhaust gas 216 in the presence of NH₃. In one or more examples, a turbulator (i.e., mixer) (not shown) can also be disposed within the exhaust conduit 214 in close proximity to the injector 236 and/or the SCR device 220 to further assist in thorough mixing of reductant 246 with the exhaust gas 216 and/or even distribution throughout the SCR device 220.

The emissions control system 34 further includes a reductant delivery system 232 that introduces the reductant 246 to the exhaust gas 216. The reductant delivery system 232 includes a reductant supply 234, an injector 236. The reductant supply 234 stores the reductant 246 and is in fluid communication with the injector 236. The reductant 246 may include, but is not limited to, NH₃. Accordingly, the injector 236 may inject a selectable amount of reductant 246 into the exhaust gas conduit 214 such that the reductant 246 is introduced to the exhaust gas 216 at a location upstream of the SCR device 220.

In one or more examples, the emissions control system 34 further includes a control module 238 operably connected via a number of sensors to monitor the engine 26 and/or the exhaust gas treatment system 34. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. For example, module 238 can execute a SCR chemical model, as described below. The control module 238 can be operably connected to ICE system 24, SCR device 220, and/or one or more sensors. As shown, the sensors can include an upstream NOₓ sensor 242 and downstream NOₓ sensor 242′, disposed downstream of SCR device 220, each of which are in fluid communication with exhaust gas conduit 214. In one or more examples, the upstream NOx sensor 242 is disposed downstream of the ICE 26 and upstream of both SCR device 220 and the injector 236. The upstream NOₓ sensor 242 and the downstream NOₓ sensor 242′ detect a NOₓ level proximate their location within exhaust gas conduit 214, and generate a NOx signal, which corresponds to the NOx level. A NOx level can comprise a concentration, a mass flow rate, or a volumetric flow rate, in some embodiments. A NOx signal generated by a NOx sensor can be interpreted by control module 238, for example. Control module 238 can optionally be in communication one or more temperature sensors, such as upstream temperature sensor 244, disposed upstream from SCR device 220.

The sensors of the emissions control system 34 may further include at least one pressure sensor 230 (e.g., a delta pressure sensor). The delta pressure sensor 230 may determine the pressure differential (i.e., Δp) across the SCR device 220. Although a single delta pressure sensor 230 is illustrated, it is appreciated that a plurality of pressure sensors may be used to determine the pressure differential of the SCR device 220. For example, a first pressure sensor may be disposed at the inlet of the SCR device 220 and a second pressure sensor may be disposed at the outlet of the SCR device 220. Accordingly, the difference between the pressure detected by the second delta pressure sensor and the pressure detected by the first delta pressure sensor may indicate the pressure differential across the SCR device 220. It should be noted that in other examples, the sensors can include different, additional, or fewer sensors than those illustrated/described herein.

In one or more examples, the SCR device 220 includes one or more components that utilize the reductant 246 and a catalyst to transform NO and NO₂ from the exhaust gases 216. The SCR device 220 can include, for example, a flow-through ceramic or metal monolith substrate that can be packaged in a shell or canister having an inlet and an outlet in fluid communication with the exhaust gas conduit 214 and optionally other exhaust treatment devices. The shell or canister can ideally comprise a substantially inert material, relative to the exhaust gas constituents, such as stainless steel. The substrate can include a SCR catalyst composition applied thereto.

The substrate body can, for example, be a ceramic brick, a plate structure, or any other suitable structure such as a monolithic honeycomb structure that includes several hundred to several thousand parallel flow-through cells per square inch, although other configurations are suitable. Each of the flow-through cells can be defined by a wall surface on which the SCR catalyst composition can be washcoated. The substrate body can be formed from a material capable of withstanding the temperatures and chemical environment associated with the exhaust gas 216. Some specific examples of materials that can be used include ceramics such as extruded cordierite, α-alumina, silicon carbide, silicon nitride, zirconia, mullite, spodumene, alumina-silica-magnesia, zirconium silicate, sillimanite, petalite, or a heat and corrosion resistant metal such as titanium or stainless steel. The substrate can comprise a non-sulfating TiO₂ material, for example. The substrate body can be a PF device, as will be discussed below.

The SCR catalyst composition is generally a porous and high surface area material which can operate efficiently to convert NOₓ constituents in the exhaust gas 216 in the presence of a reductant 246, such as ammonia. For example, the catalyst composition can contain a zeolite impregnated with one or more base metal components such as iron (Fe), cobalt (Co), copper (Cu), vanadium (V), sodium (Na), barium (Ba), titanium (Ti), tungsten (W), and combinations thereof. In a particular embodiment, the catalyst composition can contain a zeolite impregnated with one or more of copper, iron, or vanadium. In some embodiments the zeolite can be a β-type zeolite, a Y-type zeolite, a ZM5 zeolite, or any other crystalline zeolite structure such as a Chabazite or a USY (ultra-stable Y-type) zeolite. In a particular embodiment, the zeolite comprises Chabazite. In a particular embodiment, the zeolite comprises SSZ. Suitable SCR catalyst compositions can have high thermal structural stability, particularly when used in tandem with particulate filter (PF) devices or when incorporated into SCRF devices, which are regenerated via high temperature exhaust soot burning techniques.

The SCR catalyst composition can optionally further comprise one or more base metal oxides as promoters to further decrease the SO₃ formation and to extend catalyst life. The one or more base metal oxides can include WO₃, Al₂O₃, and MoO₃, in some embodiments. In one embodiment, WO₃, Al₂O₃, and MoO₃ can be used in combination with V₂O₅.

The SCR catalyst generally uses the reductant 246 to reduce NOₓ species (e.g., NO and NO₂) to harmless components. Harmless components include one or more of species which are not NOₓ species, such as diatomic nitrogen, nitrogen-containing inert species, or species which are considered acceptable emissions, for example. The reductant 246 can be ammonia (NH₃), such as anhydrous ammonia or aqueous ammonia, or generated from a nitrogen and hydrogen rich substance such as urea (CO(NH₂)₂). Additionally or alternatively, the reductant 246 can be any compound capable of decomposing or reacting in the presence of exhaust gas 216 and/or heat to form ammonia. Equations (1)-(5) provide exemplary chemical reactions for NOₓ reduction involving ammonia.

6NO+4NH₃→5N₂+6H₂O (1)

4NO+4NH₃+O₂→4N₂+6H₂O (2)

6NO₂+8NH₃→7N₂+12H₂O (3)

2NO₂+4NH₃+O₂→3N₂+6H₂O (4)

NO+NO₂+2NH₃→2N₂+3H₂O (5)

It should be appreciated that Equations (1)-(5) are merely illustrative, and are not meant to confine the SCR device 220 to a particular NOx reduction mechanism or mechanisms, nor preclude the operation of other mechanisms. The SCR device 220 can be configured to perform any one of the above NOx reduction reactions, combinations of the above NOx reduction reactions, and other NOx reduction reactions.

The reductant 246 can be diluted with water in various implementations. In implementations where the reductant 246 is diluted with water, heat (e.g., from the exhaust) evaporates the water, and ammonia is supplied to the SCR device 220. Non-ammonia reductants can be used as a full or partial alternative to ammonia as desired. In implementations where the reductant 246 includes urea, the urea reacts with the exhaust to produce ammonia, and ammonia is supplied to the SCR device 220. Reaction (6) below provides an exemplary chemical reaction of ammonia production via urea decomposition.

CO(NH₂)₂+H₂O→2NH₃+CO₂ (6)

It should be appreciated that Equation (6) is merely illustrative, and is not meant to confine the urea or other reductant 246 decomposition to a particular single mechanism, nor preclude the operation of other mechanisms.

The SCR catalyst can store (i.e., absorb, and/or adsorb) reductant for interaction with exhaust gas 216. For example, the reductant 246 can be stored within the SCR device 220 or catalyst as ammonia. A given SCR device 220 has a reductant capacity, or an amount of reductant or reductant derivative it is capable of storing. The amount of reductant stored within an SCR device 220 relative to the SCR catalyst capacity can be referred to as the SCR “reductant loading”, and can be indicated as a % loading (e.g., 90% reductant loading) in some instances. During operation of SCR device 220, injected reductant 246 is stored in the SCR catalyst and consumed during reduction reactions with NOx species and must be continually replenished. Determining the precise amount of reductant 246 to inject is critical to maintaining exhaust gas emissions at acceptable levels: insufficient reductant levels within the system 34 (e.g., within SCR device 220) can result in undesirable NOx species emissions (“NOx breakthrough”) from the system (e.g., via a vehicle tailpipe), while excessive reductant 246 injection can result in undesirable amounts of reductant 246 passing through the SCR device 220 unreacted or exiting the SCR device 220 as an undesired reaction product (“reductant slip”). Reductant slip and NOx breakthrough can also occur when the SCR catalyst is below a “light-off” temperature, for example if the SCR device 220 is saturated with NH3 (i.e. no more storage sites). SCR dosing logic can be utilized to command reductant 246 dosing, and adaptations thereof, and can be implemented by module 238, for example.

A reductant injection dosing rate (e.g., grams per second) can be determined by a SCR chemical model which predicts the amount of reductant 246 stored in the SCR device 220 based on signals from one or more of reductant 246 injection (e.g., feedback from injector 236) and upstream NOx (e.g., NOx signal from upstream NOx sensor 242). The SCR chemical model further predicts NOx levels of exhaust gas 216 discharged from the SCR device 220. The SCR chemical model can be implemented by control module 238. The SCR chemical model can be updatable by one or more process values over time, for example. A dosing governor (not shown), such as one controlled by module 238, monitors the reductant storage level predicted by the SCR chemical model, and compares the same to a desired reductant storage level. Deviations between the predicted reductant storage level and the desired reductant storage level can be continuously monitored and a dosing adaptation can be triggered to increase or decrease reductant dosing in order to eliminate or reduce the deviation. For example, the reductant dosing rate can be adapted to achieve a desired NOₓ concentration or flow rate in exhaust gas 216 downstream of the SCR device 220, or achieve a desired NOₓ conversion rate. A desired conversion rate can be determined by many factors, such as the characteristics of SCR catalyst type and/or operating conditions of the system (e.g., ICE 26 operating parameters).

Over time, inaccuracies of the SCR chemical model can compound to appreciative errors between modeled SCR reductant storage level and actual storage level. Accordingly, the SCR chemical model can be continuously corrected to minimize or eliminate errors. One method for correcting an SCR chemical model includes comparing the modeled SCR discharge exhaust gas NOx levels to the actual NOx levels (e.g., as measured by downstream NOx sensor 242′) to determine a discrepancy, and subsequently correcting the model to eliminate or reduce the discrepancy. Because NOx sensors (e.g., downstream NOx sensor 242′) are cross-sensitive to reductant (e.g., NH₃) and NOx, it is critical to distinguish between reductant signals and NOx signals as reductant slip can be confused with insufficient NOx conversion.

In one or more examples, a passive analysis technique used to distinguish between reductant signals and NOx signals is a correlation method which includes comparing the upstream NOx concentration (e.g., such as measured by upstream NOx sensor 242) movement with the downstream NOx concentration (e.g., such as measured by downstream NOx sensor 242′), wherein diverging concentration directions can indicate an increase or decrease in reductant slip. The correlation analysis identifies when the measurements from the downstream NOx sensor 242′ are following the pattern of measurements from (i.e. moving like) the upstream NOx sensor 242. The correlation is a statistical measure of the strength and direction of a linear relationship between the two NOx sensors. For example, if the upstream NOx concentration decreases and downstream NOx concentration increases, reductant slip can be identified as increasing. Similarly, if the upstream NOx concentration increases and downstream NOx concentration decreases, reductant slip can be identified as decreasing. Alternatively, or in addition, a second passive analysis technique used to distinguish between reductant signals and NOx signals is a frequency analysis. NOx signals generated by NOx sensors can include multiple frequency components (e.g., high frequency and low frequency) due to the variation of the NOx and reductant concentrations during transient conditions. High frequency signals generally relate only to NOx concentration, while low frequency signals generally relate to both NOx concentration and reductant concentration. High frequency signals for upstream NOx and downstream NOx are isolated and used to calculate a SCR NOx conversion ratio, which is then applied to the isolated low pass upstream NOx signal to determine a low frequency downstream NOx signal. The calculated low frequency downstream NOx signal is then compared to the actual isolated low frequency downstream NOx signal, wherein a deviation between the two values can indicate reductant slip.

A limitation of the correlation and frequency passive analysis techniques is that they cannot be implemented while the SCR is in steady state. “Steady state” is determined, for example, by taking the root mean square value of a NOx signal upstream from SCR device 220 (e.g., such as measured by upstream NOx sensor 242) over a moving time frame; a sufficiently small value indicates a minimal variation in upstream NOx concentration and the SCR can be considered to be in steady state. For example, a steady state condition can be comprise a root mean square value of the upstream NOx concentration of less than a predetermined value, such as about 30 ppm, less than about 20 ppm, or less than about 10 ppm. SCR steady state conditions can often correlate with ICE 26 steady state conditions (e.g., generally consistent RPM, fuel injection, temperature, etc.) Intrusive tests can be used to distinguish between reductant signals and NOx signals, which include halting all or most reductant dosing for a period of time. While intrusive tests can be performed under steady state conditions, they can, in some circumstances, yield undesirable exhaust emissions during the test period, such as emissions with an increased NOx concentration.

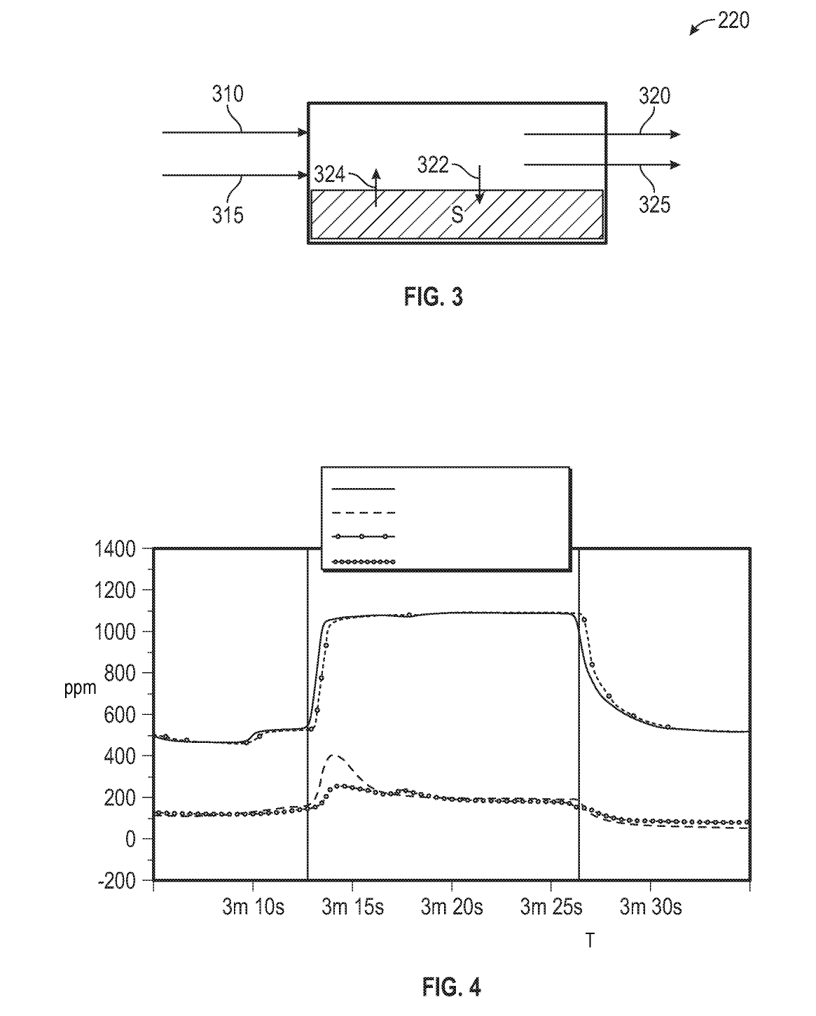

FIG. 3 illustrates an example flow of the gas exhaust through the SCR device 220, according to one or more embodiments. The control module 238 measures the flow rate (F) of gas volume, and concentration C of the gas. For example, the control module 238 determines an input flow-rate of NOx 310 of the SCR device 220 as FC_{NOx,in}, where F is the volume of the incoming gas 216, and C_{NOx,in} is the inlet concentration of NOx in the incoming gas 216. Similarly, FC_{NH3,in} is the volume of the flow-rate of NH₃ 315 in the incoming gas 216, C_{NH3,in} being the inlet concentration of NH₃. Further, compensating for the amount of adsorption 322 and amount of desorption 324, and the amounts reacted on the catalyst surface, the control module 238 may determine C_{NH3} as the SCR concentration of NH₃, and C_{NOx} as SCR concentration of NOx.

Accordingly, FC_{NOx} is the NOx outlet volume flow rate 320 of NOₓ through the outlet of the SCR device 220. In one or more examples, the control module 238 may determine W_{NOx}FC_{NOx} as mass flow rate of NOx, where W_{NOx} is the molecular weight of NOx. Similarly, for NH₃, the outlet volume flow rate 325 is FC_{NH3} with the mass flow rate of NH₃ being W_{NH3}FC_{NH3}.

As described earlier, the control module 238 controls the reductant injection rate precisely; such as ammonia producing urea aqueous solution injection rate. An insufficient injection may result in unacceptably low NOx conversions. An injection rate that is too high results in release of ammonia from the SCR device 220. These ammonia emissions from SCR systems are known as ammonia slip.

Accordingly, referring back to FIGS. 2 and 4, the control module 238 controls operation of the injector 236 based on the chemical model and desired NH3 storage setpoint to determine an amount of reductant 246 to be injected as described herein. The control module 238 may determine a correction coefficient corresponding to the reductant storage based on monitoring the one or more sensors, and may more precisely control the amount of injected reductant provided by the injector 236. For example, the control module 238 determines a reductant injector energizing time correction coefficient to further reduce or eliminate discrepancy between the chemical model and actual SCR outlet NOx emissions. Alternatively, or in addition, the control module 238 determines a NH₃ set-point correction to reduce or eliminate discrepancy between the chemical model and actual SCR outlet NOx emissions. Accordingly, the supply of reductant 246 may be utilized more efficiently. For example, the reducing agent injected into the exhaust gas 216 may form NH₃ when injected into the exhaust gas 216. Accordingly, the control module 238 controls an amount of NH₃ supplied to the SCR device 220. The SCR catalyst adsorbs (i.e., stores) NH₃. The amount of NH₃ stored by the SCR device 220 may be referred to hereinafter as an “NH₃ storage level.” The control module 238 may control the amount of NH₃ supplied to the SCR device 220 to regulate the NH₃ storage level. NH₃ stored in the SCR device 220 reacts with NOx in the exhaust gas 216 passing therethrough.

In one or more examples, the percentage of NOx that is removed from the exhaust gas 216 entering the SCR device 220 may be referred to as a conversion efficiency of the SCR device 220. The control module 238 may determine the conversion efficiency of the SCR device 220 based on NOxᵢₙ and NOxₒᵤₜ signals generated by the first (upstream) NOx sensor 242 and second (downstream) NOx sensor 242′ respectively. For example, the control module 238 may determine the conversion efficiency of the SCR device 220 based on the following equation:

SCR_{eff}═(NOxᵢₙ−NOxₒᵤₜ)/NOxᵢₙ (7)

NH₃ slip can also be caused because of an increase in the temperature of the SCR catalyst. For example, NH₃ may desorb from the SCR catalyst when the temperature increases at times when the NH₃ storage level is near to the maximum NH₃ storage level. NH₃ slip may also occur due to an error (e.g., storage level estimation error) or faulty component (e.g., faulty injector) in the emissions control system 34.

Typically, the control module 238 estimates an NH₃ storage level of the SCR device 220 based on the chemical model. In one or more examples, the storage set-point (“set-point”) is calibrate-able. The control module 238 uses the chemical model to estimate the current storage level of NH₃ in the SCR device 220, and a storage level governor provides feedback to the injection controls to determine the injection rate to provide NH₃ for reactions according to the chemical model and to maintain a target storage level. The set-point may indicate a target storage level for given operating conditions (e.g., a temperature of the SCR catalyst). Accordingly, the set-point may indicate a storage level (S) and a temperature (T) of the SCR device 220. The set-point may be denoted as (S, T). The control module 238 controls the reductant injector 236 to manage the amount of reducing agent injected into the exhaust gas 216 to adjust the storage level of the SCR device 220 to the set-point. For example, the control module 238 commands the injector 236 to increase or decrease the storage level to reach the set-point when a new set-point is determined. Additionally, the control module 238 commands the reductant injector 236 to increase or decrease the storage level to maintain the set-point when the set-point has been reached.

The technical features described herein facilitate the emissions control system 34 to perform steady state ammonia slip detection. Typically, in the steady state, ammonia slip detection is performed by disabling exhaustive fluid (DEF) injection. However, such techniques may potentially increase NOx emissions during DEF injection dose-off events. The technical features described herein address such technical challenges and improve the SCR device 220, and thereby the emissions control system 34, by performing the ammonia slip and/or NOx breakthrough detection by modulating engine out NOx rather than by disabling DEF injection to intrusively detect the presence of NH₃ slip or NOx breakthrough in steady state operating conditions, where other NH₃ slip detection strategies are typically ineffective. The use of engine out NOx modulation can prevent the tailpipe NOx emissions increase that correspond to DEF injection disablement.

In one or more examples, the control module 238 step modulates the engine out NOx emission using base engine control for one modulation event, and monitors corresponding change in the NOx measurements, for example from the downstream NOx sensor 242′. Alternatively, or in addition, the control module 238 modulates the engine out NOx multiple times via base engine control until a predetermined threshold value of NOx emission is reached, and uses a correlation and frequency based comparison of corresponding NOx measurements from the NOx sensor with the engine out NOx. In one or more examples, the root mean square of the engine out NOx is used as the threshold value. Further, in one or more examples, the control module 238 de-modulates engine out NOx emissions to return to the original state.

In one or more examples, the control module 238 modulates the ICE, for example by cycling exhaust gas recirculation (EGR). FIG. 4 illustrates an example scenario where the SCR device 220 is underdosed, according to one or more embodiments. For example, changes in values of the engine out NOx 410 are depicted in response to a first modulation 405 and a second modulation 415. The second modulation 415 may be a demodulation to an original state, that is prior to the first modulation 405. The engine out NOx is the amount or concentration of the NOx in the exhaust gas 216 as the exhaust gas 216 exits the ICE 26. FIG. 4 further illustrates corresponding changes in the SCR out NOx measurements 420, which are measured by the downstream NOx sensor 242′. In the example scenario depicted, as the engine out NOx is increased, the downstream NOx sensor measurement also increases, and as the engine out NOx is decreased, the downstream NOx sensor measurement also decreases in an underdosed (NOx breakthrough) condition.

The control module 238 modulates the engine out NOx by causing a change in the ICE 26 operation. For example, in one or more examples, the modulation includes cycling exhaust gas recirculation of the ICE 26, which can cause the fuel to burn at a slower/faster rate, thus causing the exhaust gas 216 to include less/more NOx respectively. The rate at which the exhaust gas is recirculated into the ICE 26 for the modulation is predetermined so that an operator and/or passenger of the vehicle 10 does not feel a change in the operation of the ICE 26.

In one or more examples, the modulation changes the rate at which fuel is injected into the ICE 26, which changes the rate at which NOx is emitted by the ICE 26, as depicted in FIG. 4. The rate by which the fuel injection is modified for the modulation is predetermined so that an operator and/or passenger of the vehicle 10 does not feel a change in the operation of the ICE 26. Further, in one or more examples, the modulation changes injection timing (not the rate) which affects the combustion efficiency and thus engine out NOx emissions.

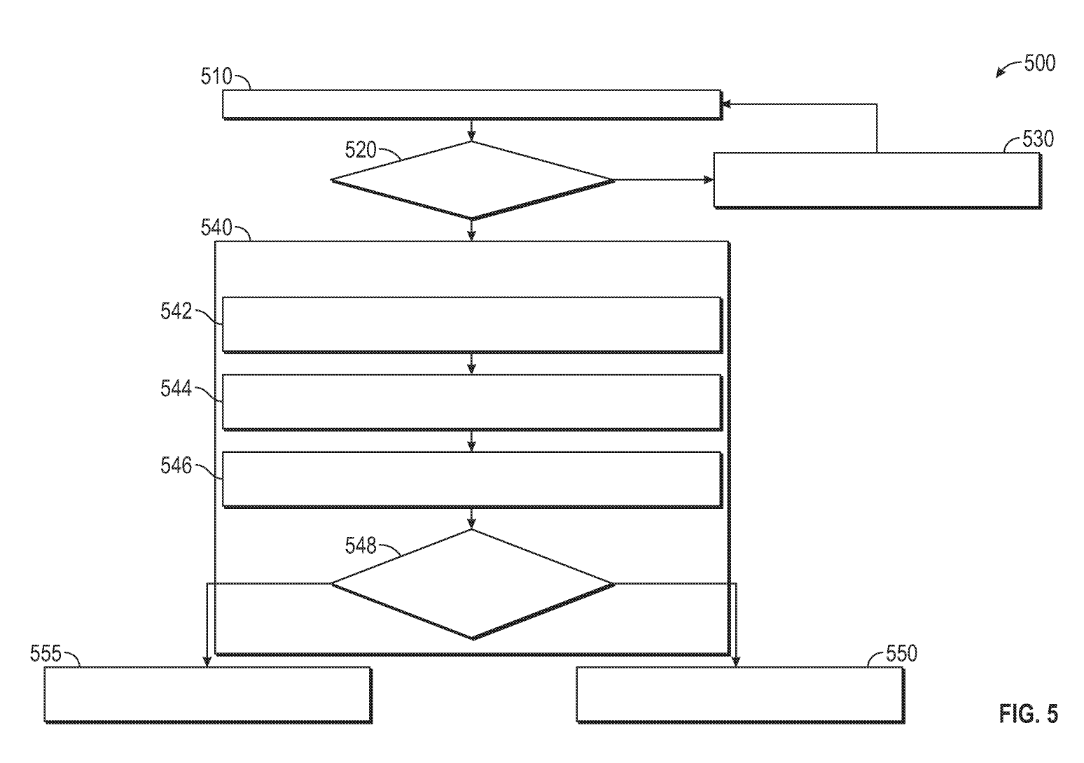

FIG. 5 illustrates a flowchart of an exemplary method 500 for detecting ammonia slip and/or reductant breakthrough in an SCR device according to one or more embodiments. The method also determines a dosing status of the SCR device 220, the dosing status indicative of whether the SCR device 220 is overdosed or underdosed. The controller 38, in one or more examples, implements the method 500. Alternatively, one or more electric circuits implement the method 500. In one or more examples, the method 500 is implemented by execution of logic that may be provided or stored in the form of computer readable and/or executable instructions in a non-transitory medium, such as a memory device.

The method 500 includes checking an engine operating condition, as shown at 510. For example, it is checked to see if the ICE 26 is in a preselected engine operating condition, such as a “steady state” operating condition where the NOₓ produced by the engine is substantially constant, as shown at 520. For example, a steady state operating condition may correspond to a condition where the vehicle 10 is motoring, e.g., engine speed or load is substantially constant. The method continues to detect NH₃ slip detection for other operating states of the ICE 26 and loops through such steps until the preselected steady state operating condition is detected, as shown at 530.

If the ICE 26 is detected to be operating in the steady state, the method performs a steady state NH₃ slip detection check or test for the steady state operation of the ICE 26 by engine out NOx modulation, as shown at 540. The steady state NH₃ slip detection check includes modulating the engine in a predetermined manner by changing engine operation, as shown at 542. In one or more examples, the modulation includes modifying the exhaust gas recirculation, modifying fuel injection rate and/or timing, or other engine operating parameters by a predetermined value.

The NH3 slip detection check further includes determining one or more gradients in the NOx measurements from SCR downstream NOx sensor 242′, as shown at 544. For example, the control module 238 receives the NOx measurement from the SCR downstream NOx sensor 242′ and computes the gradients by determining differences between pairs of most recent NOx measurements from the downstream NOx sensor 242′. Alternatively, the gradient is computed as a slope of a curve represented by the NOx measurements. In one or more examples, the NOx measurements are captured at the time the engine out NOx is modulated, for example when the EGR is switched on/off.

Further, the gradient is compared with a threshold, as shown at 546. In one or more examples, the threshold is a predetermined value corresponding to the modulation. Alternatively, or in addition, the control module 238 computes the threshold value based on the chemical model of the SCR device 220. For example, the threshold value is determined based on the semi-closed loop calculations described herein, along with one or more sensor values, such as inlet/outlet temperature, inlet/outlet pressure, and earlier NOx measurements, among others. In one or more examples, a difference between the gradient in the measurements and the threshold value is computed. The difference may be referred to as a modulation gradient error, in one or more examples.

If the modulation gradient error is above a specific value (gradient>threshold value by at least a specific value), it is deemed that NOx breakthrough is detected, and the SCR device 220 is adapted accordingly, as shown at 548 and 550. Instead, if the gradient in the measurements does not exceed the predetermined threshold (gradient<threshold), it is deemed that steady state NH3 slip is detected, and the SCR device 220 is adapted accordingly, as shown at 548 and 555. Thus, the method facilitates ammonia slip detection in steady state only, and consequently an input condition for the SCR device adaptation. For example, the adaptation includes adjusting a reductant dosing rate, for example the frequency of the dosing and/or the amount of reductant in each dose. It should be noted that the SCR device adaptation performed in response to the NOx breakthrough detection is opposite to the adaptation in response to the NH3 slip detection. For example, in case of the NOx breakthrough detection, reductant dosage is increased and in case of the NH3 slip detection, reductant dosage is decreased.

In one or more examples, the NOx measurement and the threshold value may indicate a concentration of NOx in the exhaust gases 216. In such a case, in one or more examples, the predetermined value may be a predetermined concentration of NOx, such as 0.5 ppm (or any other value). It should be noted that in one or more examples, the NOx measurement and threshold value used may be a NOx flow rate, or any other NOx attribute (instead of the NOx concentration).

In other words, if the modulation gradient is less than (or equal to) the predetermined threshold, the SCR device 220 is deemed to be operating in a steady state with a NH₃ slip, and consequently the SCR device 220 is adapted accordingly, as shown at 555. If the modulation gradient is greater than the predetermined threshold, the SCR device 220 is deemed to be operating with a NOx breakthrough, as shown at 550. For example, the reductant dosing rate is adapted to achieve the desired NOₓ concentration or flow rate in exhaust gas 216 downstream of the SCR device 220, or achieve a desired NOₓ conversion rate.

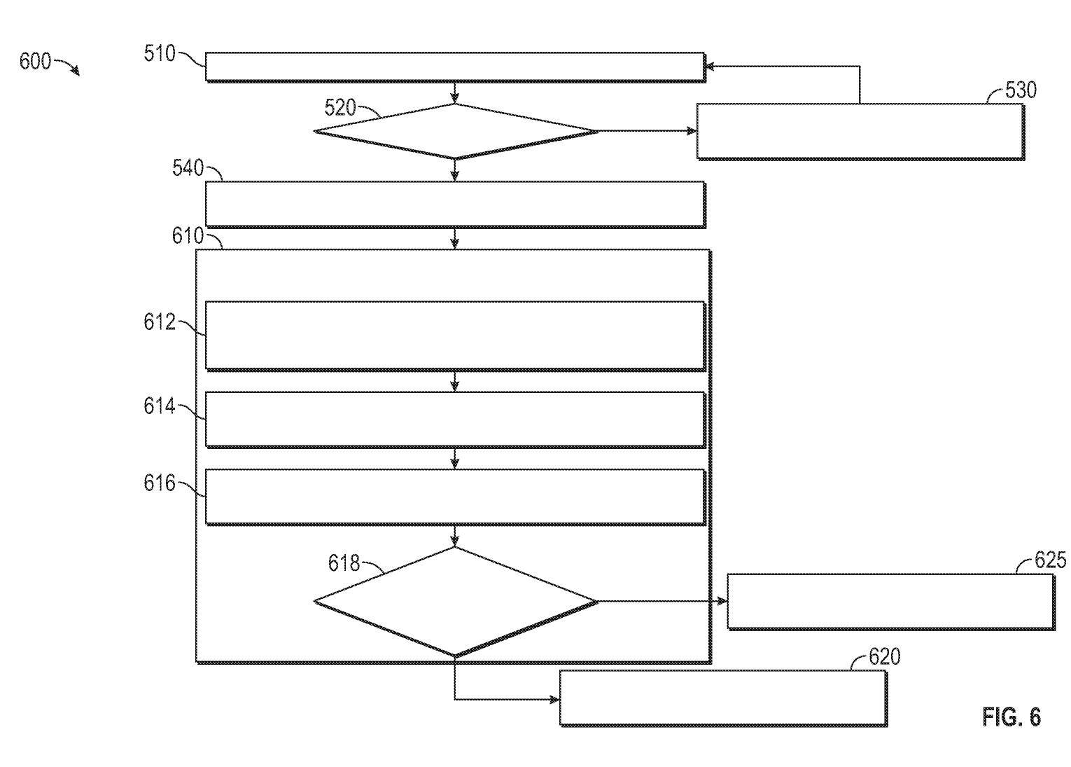

FIG. 6 illustrates a flowchart of an example method 600 for detecting ammonia slip in an SCR device according to one or more embodiments. The method also determines a dosing status of the SCR device 220. The controller 38, in one or more examples, implements the method 600. Alternatively, one or more electric circuits implement the method 600. In one or more examples, the method 600 is implemented by execution of logic that may be provided or stored in the form of computer readable and/or executable instructions in a non-transitory medium, such as a memory device.

Similar to the method 500, the method 600 includes checking an engine operating condition, as shown at 510. For example, it is checked to see if the ICE 26 is in a preselected engine operating condition, such as a “steady state” operating condition, as shown at 520. The method continues to detect NH₃ slip for other operating states of the ICE 26 and loop through such steps until the preselected steady state operating condition is detected, as shown at 530. If the ICE 26 is detected to be operating in the steady state, the method includes performing a steady state NH₃ slip detection for the steady state operation of the ICE 26 by engine out NOx modulation, as shown at 540, and as described herein (FIG. 5).

Further, the method 600 includes performing a steady state NH₃ slip detection for the steady state operation of the ICE 26 by engine out NOx demodulation, as shown at 610. For example, the control module 238 demodulates the engine in a predetermined manner by changing engine operation to return to original state from before the modulation (540), as shown at 612. For example, if the modulation was to turn on the EGR, demodulation includes turning the EGR off. Alternatively, if the modulation was increasing the rate of fuel injection, the demodulation includes decreasing the rate of fuel injection, and vice versa. Alternatively, or in addition, if the modulation was changing the timing of the fuel injection from a first timing to a second timing, the demodulation changes the timing back to the first timing.

The fuel injection timing includes Start of injection (SOD, which is the time at which injection of fuel into the combustion chamber of hte ICE 26 begins. For example, the SOI may be expressed as crank angle degrees (CAD) relative to top dead center (TDC) of the compression stroke. For example, the SOI may be the time that an electronic trigger is sent to a fuel injector or a signal that indicates when the fuel injector starts to open.

The control module 238 further computes a gradient in the NOx measurement from SCR downstream NOx sensor 242′, as shown at 614. For example, the control module 238 receives the NOx measurement from the SCR downstream NOx sensor 242′ and computes the gradient by determining a difference between a most recent NOx measurement from the downstream NOx sensor 242′.

Further, the gradient is compared with a threshold value, as shown at 616. In one or more examples, the threshold value is a predetermined value corresponding to the demodulation, and may be different than the threshold for the comparison during the modulation (548). Alternatively, or in addition, the control module 238 computes the threshold value based on the chemical model of the SCR device 220. The threshold value is determined based on the semi-closed loop calculations described herein, along with one or more sensor values, such as inlet/outlet temperature, inlet/outlet pressure, and earlier NOx measurements, among others. In one or more examples, a difference between the gradient in the measurements and the threshold value is computed. The difference may be referred to as a demodulation gradient error, in one or more examples.

If the demodulation gradient error is above a specific value (gradient>threshold value by at least the specific value), it is deemed that NOx breakthrough is detected, and SCR adaptation is initiated accordingly, as shown at 618 and 620. Instead, if the gradient does not exceed the predetermined threshold (gradient<threshold), it is deemed that steady state NH3 slip is detected, and the SCR device 220 is adapted accordingly, as shown at 618 and 625. For example, the adaptation includes adjusting a reductant-dosing rate, for example the frequency of the dosing and/or the amount of reductant in each dose.

For example, the NOx measurement and threshold value may indicate a concentration of NOx in the exhaust gases 216. In such a case, in one or more examples, the predetermined value may be a predetermined concentration of NOx, such as 0.5 ppm (or any other value). It should be noted that in one or more examples, the NOx measurement and threshold value used may be a NOx flow rate, or any other NOx attribute (instead of the NOx concentration). It should be noted that the predetermined threshold values used for comparing with the modulation gradient error and the demodulation gradient error are different from each other in one or more examples. In one or more examples, the modulation gradient error and the demodulation gradient error, both, are compared with a single predetermined threshold value to determine if the SCR device 220 is to be adapted.

In other words, if the demodulation gradient is less than (or equal to) the predetermined threshold, the SCR device 220 is deemed to be operating in a steady state with a NH₃ slip, and consequently the SCR device 220 is adapted, as shown at 625. If the demodulation gradient is greater than the predetermined threshold, the SCR device 220 is deemed to be operating with a NOx breakthrough, as shown at 620. For example, the reductant dosing rate is adapted to achieve the desired NOₓ concentration or flow rate in exhaust gas 216 downstream of the SCR device 220, or achieve a desired NOₓ conversion rate.

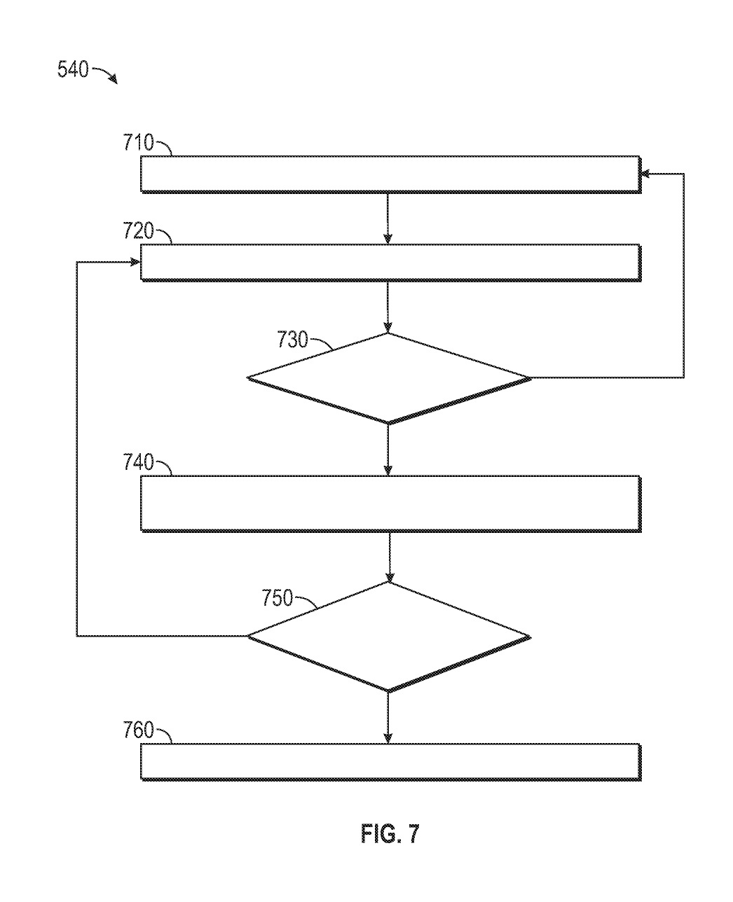

FIG. 7 depicts an example method for performing the steady state ammonia slip detection by engine out NOx modulation according to one or more embodiments. The method also determines a dosing status of the SCR device 220. In one or more examples, the steady state ammonia slip detection by engine out NOx modulation (540 in FIGS. 5 and 6) may include a single modulation and monitoring a current change in the downstream NOx measurement. Alternatively, or in addition, the modulation includes multiple modulations, and monitoring the downstream NOx measurement to ensure that changes in the measurement are corresponding to the multiple modulations made. FIG. 7 depicts an example method for the steady state ammonia slip detection by modulating engine out NOx using multiple modulations, according to one or more embodiments.

In one or more examples, the engine out NOx is modulated/demodulated by changing the operation of the ICE 26, for example by modulating EGR, as shown at 710. A corresponding engine out NOx sensor measurement is captured, as shown at 720. Further, the control module 238 checks if a threshold condition, such as the root mean square of the engine out NOx sensor measurement, has been met to stop modulating the engine out NOx, as shown at 730. The controller 38 continuously computes the root mean square of the engine out NOx sensor measurement values. In one or more examples, the root mean square is computed for a predetermined subset of the engine out NOx sensor measurement values, for example measurements captured for a predetermined duration, measurements since the vehicle 10 was most recently started, measurements since the vehicle 10 was first started, or any other predetermined engine out NOx measurements. If the threshold condition has not been met, the method loops to continue modulating the engine out NOx and capturing the corresponding downstream NOx measurements.

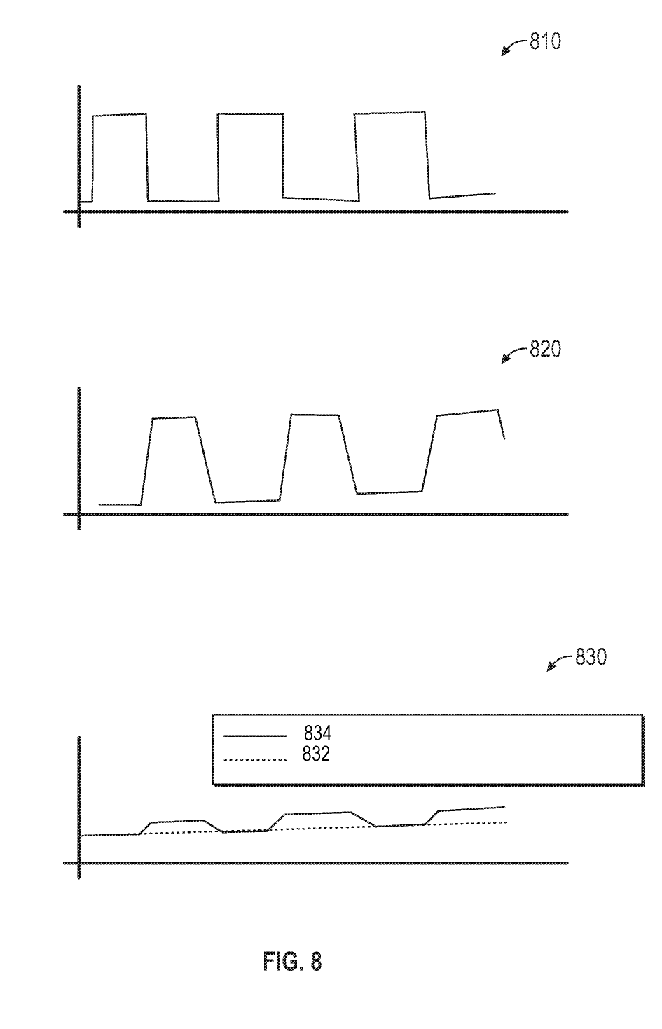

In one or more examples, the control module 238 alternatively modulates and demodulates the engine out NOx to vary the engine out NOx according to a predetermined pattern. FIG. 8 depicts an example modulation/demodulation sequence 810 by cycling the EGR on/off. FIG. 8 further depicts a corresponding engine out NOx sequence 820 according to the modulation/demodulation sequence 810. In one or more examples, the threshold condition is checked periodically, for example at a predetermined frequency, resulting in the sequences 810 and 820. It should be noted that although FIG. 8 depicts cycling EGR for modulating the engine out NOx, in other examples, the modulation/demodulation is implemented by changing the engine operation differently, for example by changing fuel injection timing.

In one or more examples, the threshold condition checked by the control module 238 to determine when to stop modulating/demodulating the engine out NOx and capturing the corresponding NOx measurements includes determining a number of times the engine out NOx has been modulated/demodulated. For example, the engine out NOx is modulated/demodulated a predetermined number of times, such as 5, 10, or any other integer. The control module 238 tracks the number of times the engine out NOx has been modulated/demodulated and compares the number with the predetermined threshold. For example, if the engine out NOx is modulated/demodulated using EGR cycling, the control module 238 tracks the number of times the EGR cycling is turned on/off. The threshold is considered to be met if the predetermined threshold value is met.

Alternatively, or in addition, the threshold condition includes keeping track of a root mean square (RMS) of the captured NOx measurements from the downstream NOx sensor 242′. In one or more examples, the controller 38 continuously computes the RMS of the engine out NOx sensor measurement values. In one or more examples, the root mean square is computed for a predetermined subset of the engine out NOx sensor measurement values, for example measurements captured for a predetermined duration, measurements since the vehicle 10 was most recently started, measurements since the vehicle 10 was first started, or any other predetermined engine out NOx measurements. The control module 238 compares the RMS value with a predetermined threshold value, and if the RMS is equal to or exceeds the RMS threshold value, the modulation/demodulation is stopped as it is deemed that the threshold condition has been met.

Once the threshold condition is met, the control module 238 compares the captured NOx measurements from the downstream NOx sensor 242′ with predicted NOx measurements, as shown at 740. If the measurements match the predictions, the control module 238 continues the operation of the SCR device 220 without any adaptation, as shown at 750. Alternatively, if the predictions and measurements do not match, the control module 238 performs an adaptation of the SCR device 220, based on whether an overdosed or underdosed condition is detected, as shown at 760. In one or more examples, the correlation and frequency based slip detection techniques described herein are further used to determine if NOx breakthrough or NH3 slip condition exists. The correlation and frequency techniques rely on signal processing, for example determining correlation of engine out and SCR out NOx sensor signals, separation of SCR out NOx sensor signals into low/high pass frequencies, and so on to detect NOx breakthrough or NH3 Slip. The technical solutions herein thus link the engine out NOx modulation with the detection strategies, such as correlation and frequency strategies which the controller 38 is reliably performing.

For example, the comparison includes a correlation method which includes comparing the downstream NOx concentration with the upstream NOx measurements, or the predicted NOx measurements, wherein diverging concentration directions can indicate an increase or decrease in reductant slip. For example, if the upstream NOx concentration decreases and downstream NOx concentration increases, reductant slip can be identified as increasing. Similarly, if the upstream NOx concentration increases and downstream NOx concentration decreases, reductant slip can be identified as decreasing. Thus, the divergence between the two sequences of NOx measurements can be used to determine a dosing status of the SCR device 220.

Alternatively, or in addition, the comparison includes a frequency analysis. NOx signals generated by NOx sensors can include multiple frequency components (e.g., high frequency and low frequency) due to the variation of the NOx and reductant concentrations during the modulation/demodulation. High frequency signals generally relate only to NOx concentration, while low frequency signals generally relate to both NOx concentration and reductant concentration. High frequency signals for upstream NOx and downstream NOx are isolated and used to calculate a SCR NOx conversion ratio, which is then applied to the isolated low pass upstream NOx signal to determine a low frequency downstream NOx signal. The calculated low frequency downstream NOx signal is then compared to the actual isolated low frequency downstream NOx signal, wherein a deviation between the two values can indicate reductant slip.

Alternatively, or in addition, the control module 238 monitors the increase/decrease in the downstream NOx measurements corresponding to the modulation/demodulations and the expected/predicted changes. Referring to FIG. 8, the NOx gradient sequence 830 depicts changes in the downstream NOx measurements corresponding to the EGR cycling sequence 810 and the corresponding engine out NOx predicted sequence 820. It should be noted that the engine out NOx values can be measured by the upstream NOx sensor 242, in one or more examples. Based on the changes in the downstream NOx measurements in relation to the EGR cycling, the control module 238 can determine overdosed (832)/underdosed (834) conditions of the SCR device 220, to detect if the SCR device 220 is experiencing NOx breakthrough or NH3 slip.

For example, if there is a rise in the downstream NOx with increase in the engine out NOx after EGR shutoff, the control module 238 may determine an underdosed condition (NOx breakthrough). Alternatively, or in addition, if the control module 238 detects a lack of rise in the downstream NOx with an increase in the engine out NOx after EGR shutoff, the control module 238 determines an overdosed (NH₃ slip) condition.

The one or more predetermined thresholds values described herein are configurable to facilitate the exhaust system to be configured according to different compliance regulations that may be used in different geographic locations or for different classes of vehicles.

The technical features herein facilitate improving the exhaust system by improving performance of steady state NH3 slip detection test. The technical features further reduce potential for increased tailpipe NOx emissions caused by DEF dose disabling, which is typically used for steady state slip detection for SCR devices. The technical features thus eliminate using auxiliary emission control device(s) (AECD) for steady state slip detection, and ensuring that the emissions control system is in compliance with applicable regulations.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An emissions control system for treating exhaust gas in a motor vehicle including an internal combustion engine, the emissions control system comprising:
a selective catalytic reduction (SCR) device;
an NOx sensor; and
a controller that is configured to detect a NH3 slip of the SCR device by:
modulating an engine out NOx from an engine;
demodulating the engine out NOx from the engine to original state;
measuring NOx upstream and downstream from the SCR device after the modulation; and
determining the NH3 slip by comparing gradients in the NOx measurement with one or more predetermined thresholds.

2. The emissions control system of claim 1, wherein the SCR device is determined to be overdosed in response to a gradient of the NOx measurement corresponding to a rise in SCR out NOx, which is measured downstream from the SCR device, not meeting a predetermined threshold.

3. The emissions control system of claim 1, wherein the SCR device is determined to be underdosed in response to a gradient of the NOx measurement corresponding to a reduction in the SCR out NOx, which is measured downstream from the SCR device, exceeding a predetermined threshold.

4. The emissions control system of claim 1, the controller further configured to adapt the SCR device in response to the NH3 slip being detected.

5. The emissions control system of claim 1, wherein the controller is further configured to:
determine an operating state of the engine; and
initialize the detection of the NH3 slip of the SCR device in response to the engine operating in a steady state.

6. The emissions control system of claim 5, wherein the controller is configured to detect the NH3 slip in the steady state at a predetermined frequency.

7. The emissions control system of claim 1, wherein the controller modulates the engine out NOx of the engine by cycling an exhaust gas recirculation of the engine.

8. The emissions control system of claim 1, wherein the modulation of the engine out NOx of the engine comprises a plurality of modulations, the NOx measurement comprises a plurality of NOx measurements, and the comparison comprises:
determining a correlation between the NOx measurements and a predetermined set of predicted NOx measurements and frequency detection of the NOx measurements.

9. The emissions control system of claim 1, wherein the controller is further configured to detect the NH3 slip by demodulating the engine out NOx from the engine to original state.

10. An exhaust system for treating exhaust gas emitted by an internal combustion engine, configured to perform a selective catalytic reduction (SCR) of exhaust gas, the exhaust system comprising:
a controller configured to detect a NH3 slip of an SCR device by:
modulating an engine out NOx from an engine;
measuring NOx downstream from the SCR device after the modulation; and
determining the NH3 slip by comparing gradients in the NOx measurement with one or more predetermined thresholds.

11. The exhaust system of claim 10, wherein the SCR device is determined to be overdosed in response to a gradient of the NOx measurement corresponding to a rise in NOx measurement downstream from the SCR device not meeting a predetermined threshold.

12. The exhaust system of claim 10, wherein the SCR device is determined to be underdosed in response to a gradient of the NOx measurement corresponding to a reduction in NOx measurement downstream from the SCR device exceeding a predetermined threshold.

13. The exhaust system of claim 10, wherein the controller is further configured to:
determine an operating state of the engine; and
initialize the detection of the dosing status of the SCR device in response to the engine operating in a steady state.

14. The exhaust system of claim 10, wherein the controller modulates the engine out NOx of the engine by cycling an exhaust gas recirculation of the engine.

15. The exhaust system of claim 10, wherein the detection of the NH3 slip further comprises demodulating the engine out NOx from the engine.

16. A computer-implemented method for controlling a selective catalytic reduction (SCR) device of an exhaust system of an internal combustion engine, the method comprising:
modulating an engine out NOx from the internal combustion engine;
measuring NOx downstream from the SCR device after the modulation; and
determining a dosing status of the SCR device by comparing gradients in the NOx measurement with one or more predetermined thresholds, the dosing status indicative of the SCR device being underdosed or overdosed.

17. The method of claim 16, wherein the dosing status of the SCR device is determined to be overdosed in response to a gradient of the NOx measurement corresponding to a rise in the NOx measurement downstream from the SCR device not meeting a predetermined threshold.

18. The method of claim 16, wherein the dosing status of the SCR device is determined to be underdosed in response to a gradient of the NOx measurement corresponding to a reduction in the NOx measurement downstream from the SCR device exceeding a predetermined threshold.

19. The method of claim 16, further comprising:
determining an operating state of the internal combustion engine; and
initializing the detection of the dosing status of the SCR device in response to the internal combustion engine operating in a steady state.

20. The method of claim 16, wherein modulating the engine out NOx of the engine comprises cycling an exhaust gas recirculation of the internal combustion engine.
